(19) United States
(12) Patent Application Publication
(10) Pub. No.: US 2009/0056564 A1
(43) Pub. Date: Mar. 5, 2009

(54) Press for processing all types of materials and having a swivelling pressing blade and pressing cover

(76) Inventors: August van der Beek, Grevenbroich (DE); Andreas Klother, Kaarst (DE); Michael Schaaf, Solingen (DE); Walter Fischer, Neuss (DE); Harald Pechtel, Neuss (DE)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 11/918,801

(22) PCT Filed: Apr. 24, 2006
(86) PCT No.: PCT/DE2006/000707

§ 371 Date: Oct. 18, 2007

(30) Foreign Application Priority Data
Apr. 22, 2005 (DE) 10 2005 018 928.8

(51) Int. Cl. B30B 9/00

(52) U.S. Cl. 100/95

(57) ABSTRACT

The invention relates to a press for processing material of any desired type, in particular metal scrap or waste, comprising a bed with a pivotable press blade and press cover for filling compression as well as delivery of the material by means of a slide for further processing and including hydraulic cylinders for driving the press blade, press cover and slide.

### FIELD OF THE INVENTION

The invention relates to a press for processing such as pressing and/or shearing material of any desired type, in particular metal scrap or waste, in which the material is formed into a strand by means of a pivotable press blade and a pivotable press cover according to the preamble of claim 1. Such a press is known from DE 34 39 002 C2 and WO 03/080323 A1.

### BACKGROUND OF THE INVENTION

It has in practice become apparent that the configuration of the bed with regard to the arrangement and configuration of the pivotable press cover is of particular importance, this as a rule already being configured as a blade in timed interaction with the side slide and slide.

Blade bed presses or shears follow, in their bed design, another principle for pressing the scrap strand: In this respect, dispensing with a side slide, the Strand, of a rectangular cross section, is formed by a blade which pivots first and which in a way replaces the side slide, and a cover which then pivots inwards. This principle has proved successful in particular for presses or shears of a relatively small structure.

The problem of the last-mentioned types, in consequence of the pivotal movements, which are decisive in terms of kinematics and force, lies on the one hand in increasing efficiency and on the other in constructing the press or shears with beds of this kind in a compact manner.

Solutions of scrap presses according to DE 39 17 293 C3 with press blades provide no corresponding suggestions.

### SUMMARY OF THE INVENTION

The object of the invention is to provide a press of the type mentioned above, which press, with optimally combined sequences of functions, has a compact constructional form and is capable of executing new method steps in coordination with selected components.

This is achieved according to the invention by a press for processing material of any desired type, in particular metal scrap or waste, comprising
a bed with in each case at least one pivotable press blade or press cover for filling and strand-like compression as well as delivery of the material by means of a slide for further processing such as pressing and/or shearing, comprising hydraulic cylinders for driving the press blade, press cover and slide,
   wherein the bed comprises a basic body which has an L-shaped cross section and pivot pins, extending diagonally opposite one another, for the press blade and press cover, and means for positioning (detecting) the respective location of the press blade and press cover are provided in the range of action of the pivot pins.

The invention is described in detail with embodiments on the basis of the drawings of a blade bed press.

### BRIEF DESCRIPTION OF THE DRAWINGS

In the drawings

FIG. 1 shows the design principle of a conventional blade bed press in cross section,

FIG. 2 shows a schematic assembly of a blade bed press according to the invention in a perspective representation,
a) as a complete system,
b) with a detail of the cutter arrangements,
c) in a shear stand,

FIG. 3 shows a further perspective representation for demonstrating the sequences of functions a) to c) according to FIG. 2,

FIG. 4 shows a blade bed press according to the invention, represented in cross section, in the positions
a) filling
b) precompression by press blade,
c) secondary compression by press cover,
d) compression by slide, and

FIG. 5 shows a graphic representation of the forces acting according to the invention (new) of the press blade/cover in comparison with the acting forces of known constructions (old).

### DETAILED DESCRIPTION OF THE DRAWINGS

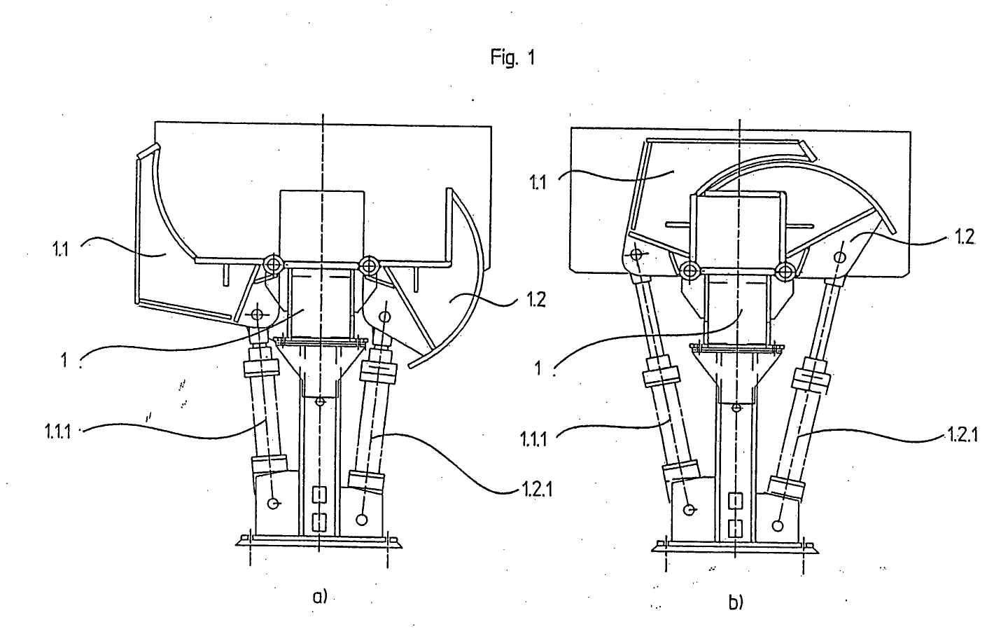

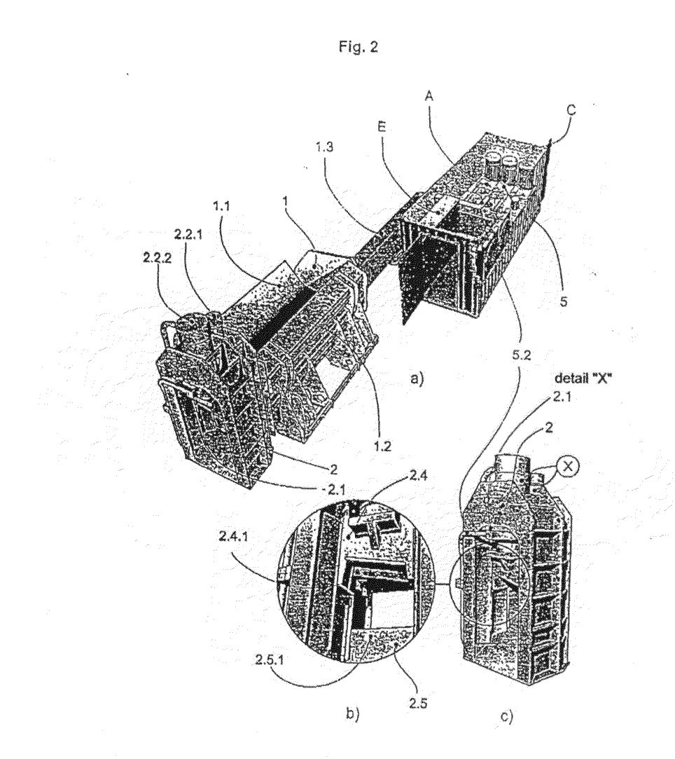

A known bed 1 of (a) prior art blade bed press/shears is represented in cross section according to FIG. 1. The location for accommodating a material 3, which is not represented, with a press blade 1.1 and press cover 1.2 in each case pivoted out is represented in position a) and the location with the press blade 1.1 and press cover 1.2 in each case pivoted in is represented in position b), in which latter location the material 3 is formed into a strand. A first hydraulic cylinder 1.1.1 and a second hydraulic cylinder 1.2.1 are provided for pivoting and exerting the pressing forces.

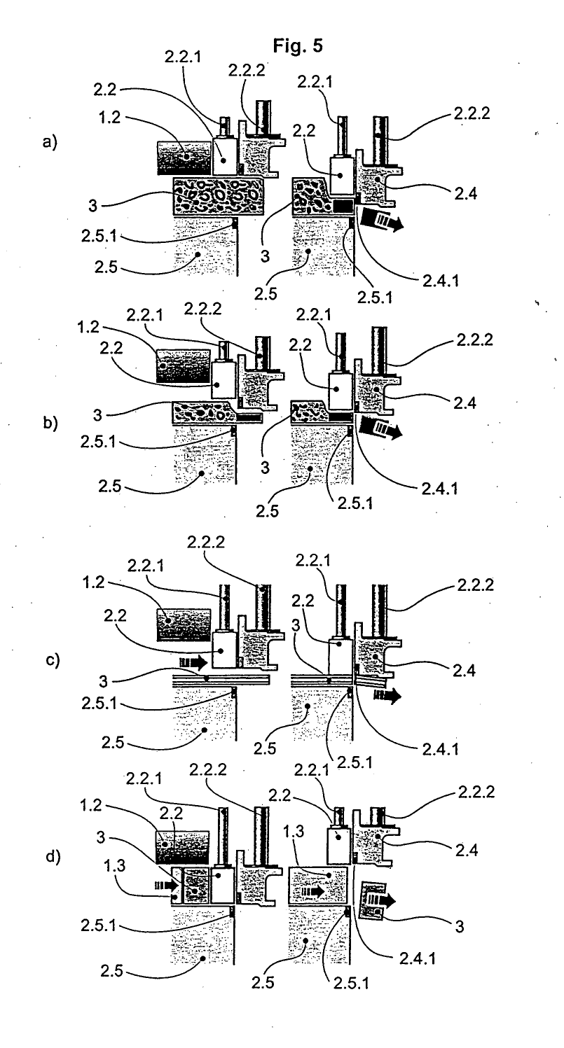

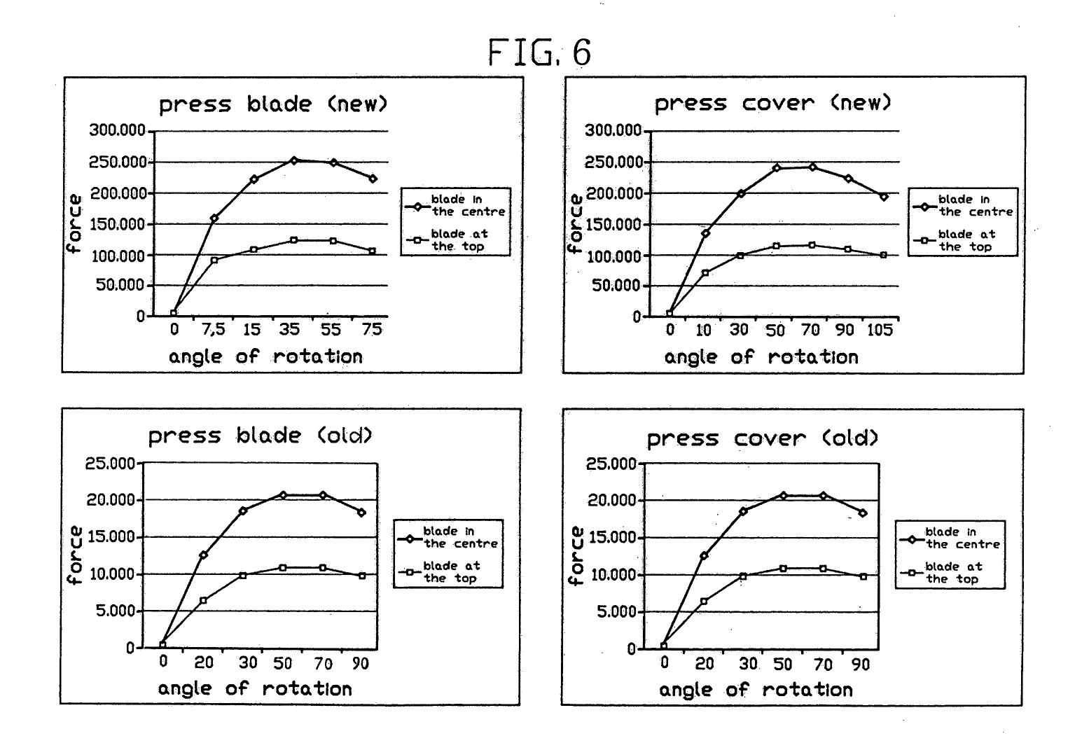

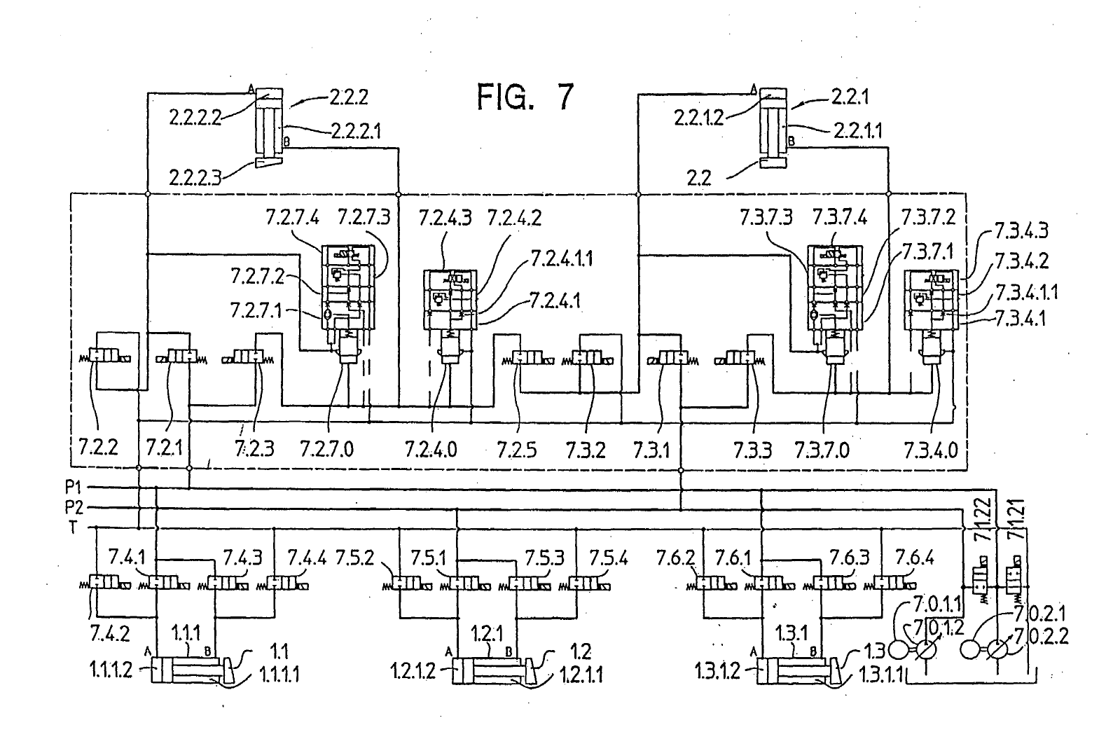

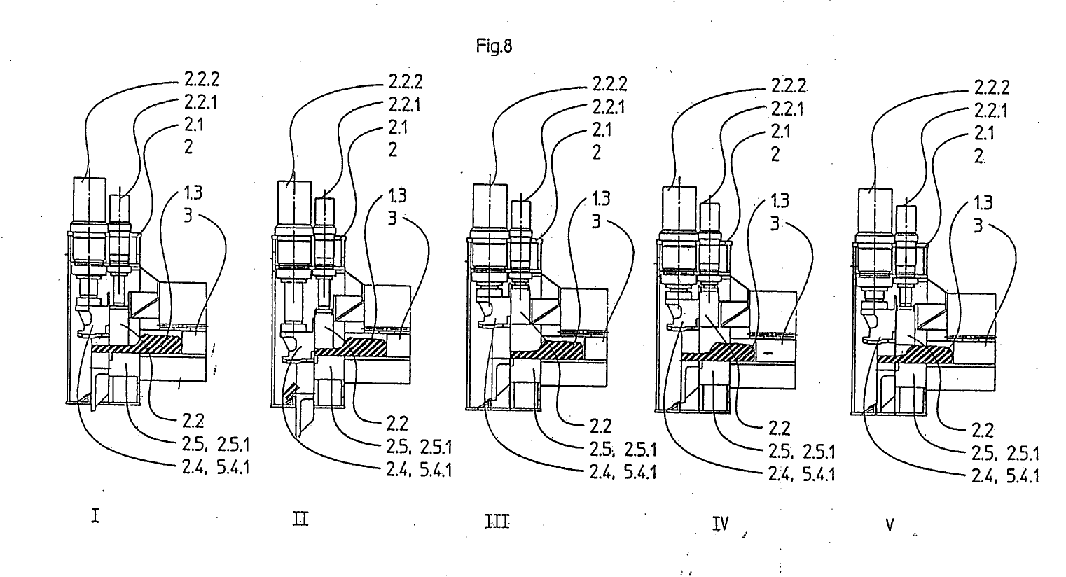

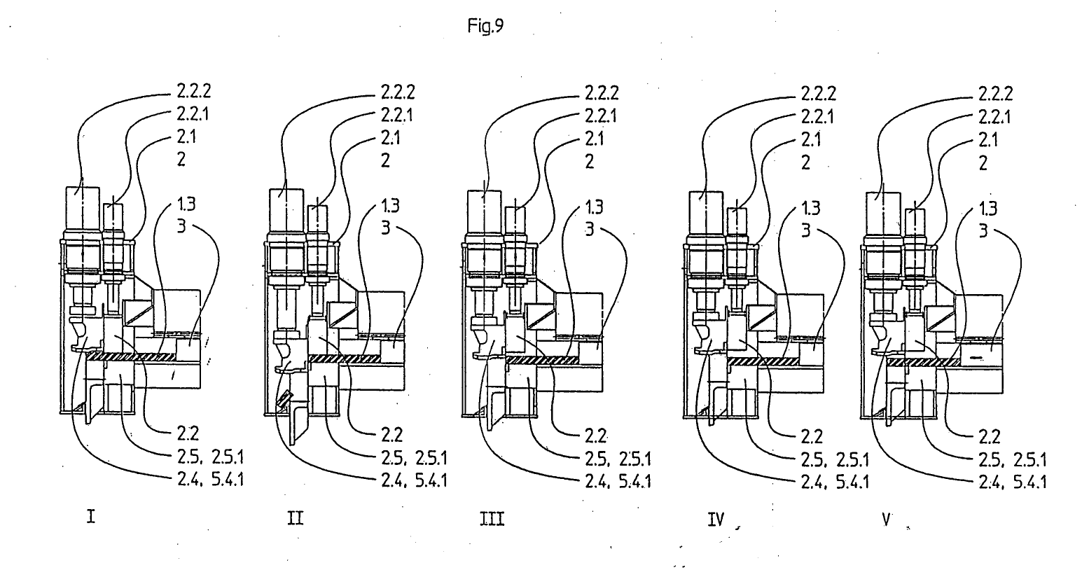

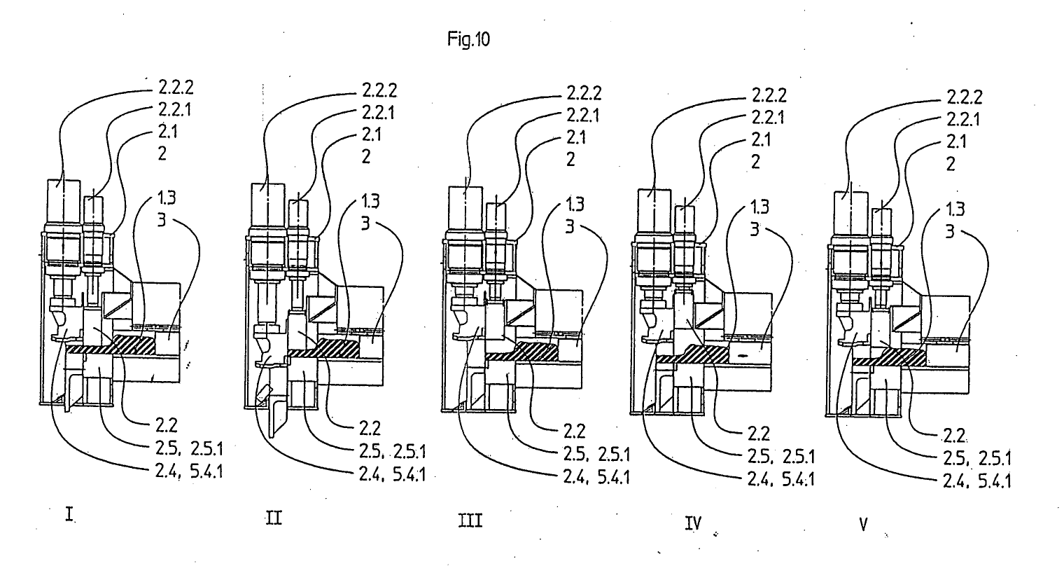

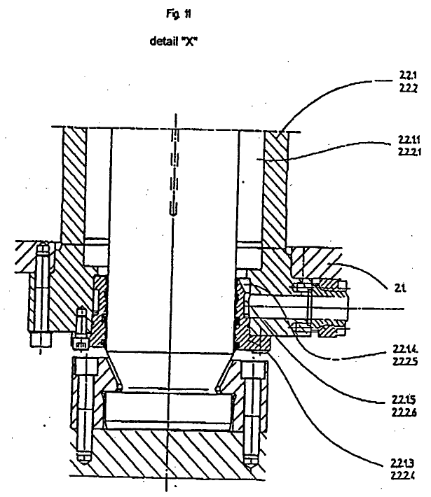

This design discloses, both with regard to the structure and the force diagram represented according to FIG. 5, disadvantages, in particular relating to the sequences of functions of the press blade 1.1 and press cover 1.2 as well as the hydraulic cylinders 1.1.1 and 1.2.1 responsible for the drive.

The complete arrangement of a blade bed shear with the associated assemblies, such as stand 2, slide 1.3, hydraulic control 5 with control block 5.1 and pipelines 5.2, is represented in the overall composition according to FIG. 2 in view a). View b) shows in this respect, by way of a segment from the stand 2 of view c), details such as a cutter carriage 2.4 with top cutter 2.4.1 and a table 2.5 with bottom cutter 2.5.1.

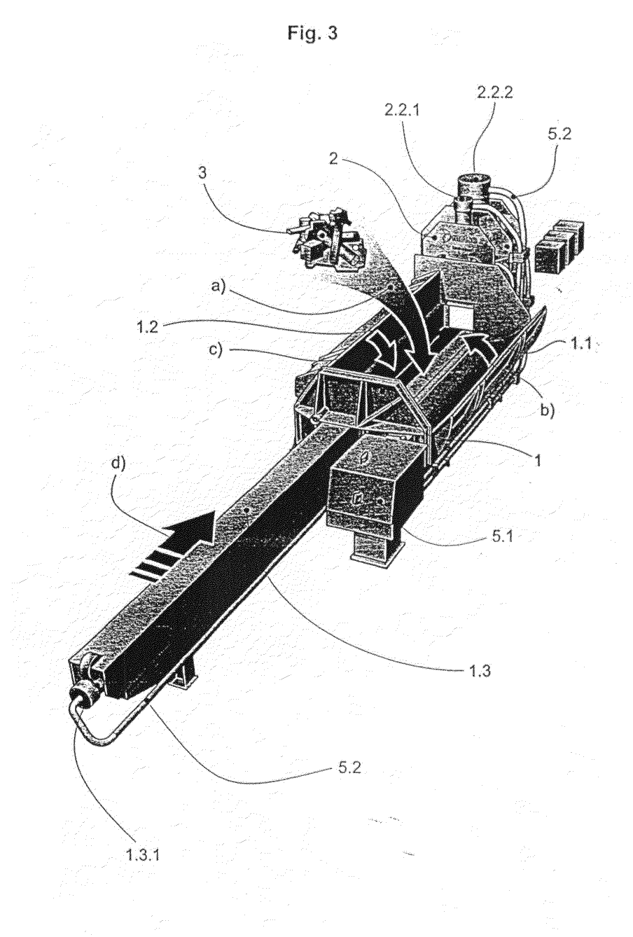

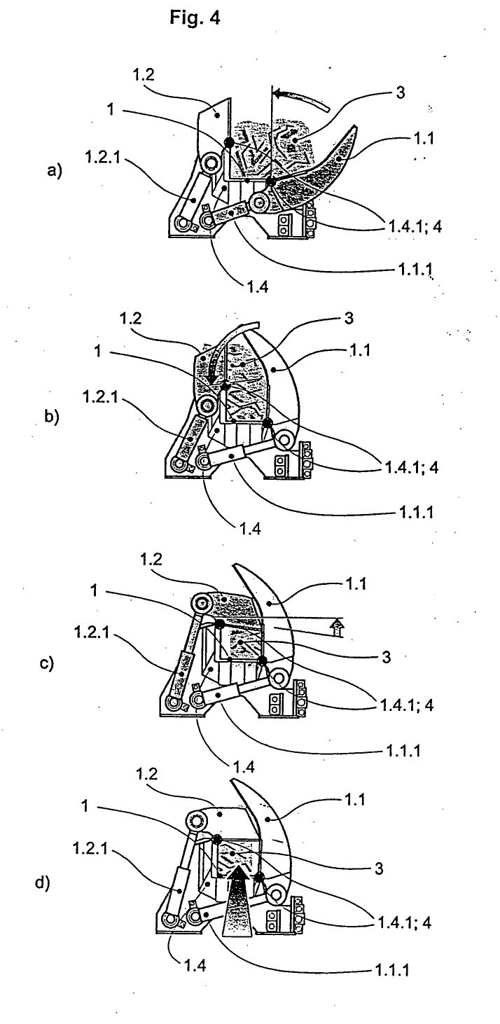

FIG. 3 demonstrates the sequences of functions in the blade bed according to the invention, namely with a), indicated by the perpendicular arrow, charging with the material 3, with b), symbolised by the horizontal arrow, the subsequent pivoting of the press blade 1.1, with c), indicated by a diagonal arrow pointing downwards, the pivoting of the press cover 1.2, according to which the strand of material 3 is formed, and finally with d), represented by a further arrow, the feed function of slide 1.3, which compresses the strand of material 3 and, with the third hydraulic cylinder 1.3.1, delivers it for processing in the stand 2.

In FIG. 4a) the filling of the material 3 is represented. According to position b) the material 3 is prepressed by the press blade 1.1. In position c) a secondary compression is effected by the press cover 1.2. During this, an overstroke may be executed by the press cover 1.2 which proves to be advantageous, depending on the material. According to position d) the slide 1.3 further compresses the formed strand of material 3 in the longitudinal direction of the bed 1. (Note: the press cover has an overstroke and travels into the contour of the press channel. Result: prevention or reduction of forces between the cover and the material when the slide advances.)

The bed 1 comprises a basic body 14 which has an L-shaped cross section and at which pivot pins 1.4.1, extending diagonally opposite one another, press blade 1.1 and press cover 1.2 are disposed, and means 4 for positioning the respective location of the press blade 1.1 and cover 1.2 are provided in the range of action of the pivot pins 1.4.1.

The functions which are integrated in the stand 2 disposed downstream of the bed 1 are not represented in detail.

An essential advantage of the invention is particularly expressed if the comparison represented in graphs of the effect of the press blade 1.1 and press cover 1.2 with respect to the prior art (old-new) according to FIG. 5 is taken into account.

According to their mounting at the pivot pins 1.4 as well as their formation as two-armed levers and their drives by means of the first and second hydraulic cylinders 1.1.1, 1.2.1, the press blade 1.1 and the press cover 1.2 develop a pressing force in a particularly highly effective way, which is represented in the function: “force relating to the angle of rotation” graphically.

In addition, after the bed 1 has been filled with material 3 and optionally after an overstroke, the press blade 1.1 is in a perpendicular position, which precompresses the material 3, and then forms a side wall of the bed (not indicated).

The press cover 1.2, which is initially vertical, is horizontal, optionally after an overstroke, and in this location forms, together with the vertical press blade 1.1, the cross section which accommodates the strand of material 3 thus formed.

The press blade 1.1 and the press cover 1.2 are expediently formed as hollow sections which increase stiffness and reduce mass in order to assist their functional effects.

In addition to a hydraulic control, the press comprises a program which permits preselection of the operating mode according to the operating modes, in particular also with a “partial or relative stroke”. If the slide 1.3 blocks in a thrust movement, i.e. forward travel, the ram 2.2 and the top cutter 2.4.1 are moved into the top end position, the imminent, remaining filling of the bed 1 with material 3 and the further sequences of functions are then executed and cut in the “full stroke” mode.

Both the hydraulic control and the program for preselecting the operating mode use the technical means 4 for positioning the press blade 1.1 and press cover 1.2, which are preferably angle encoders, and the integrated displacement measuring systems for locating the position of the slide 1.3 (this also through laser location) as well as the functions of the fourth and fifth hydraulic cylinders 2.2.1, 2.2.2 for linking and co-ordinating the sequences of functions of the acting components, such as the press blade 1.1, press cover 1.2, slide 1.3, ram 2.2 and parting tools or top cutter 2.4.1.

1-30. (canceled)

31. Press for processing material of any desired type, in particular metal scrap or waste, comprising:
a bed with in each case at least one pivotable press blade or press cover for filing and strand-like compression as well as delivery of the material by means of a slide for further processing such as pressing and/or shearing, comprising hydraulic cylinders for driving the press blade, press cover and slide,
characterised in that the bed comprises a basic body which has an L-shaped cross section and pivot pins, extending diagonally opposite one another, for the press blade and press cover, and means for positioning (detecting) the respective location of the press blade and press cover are provided in the range of action of the pivot pins.

32. Press according to claim 31, characterised in that the means for locating the respective position of the press blade and press cover are angle encoders.
